(19) United States
(12) Patent Application Publication
(10) Pub. No.: US 2010/0161721 A1
(43) Pub. Date: Jun. 24, 2010

(54) PROVIDING THREADED CONTEXT IN WEB APPLICATION SOFTWARE

(76) Inventor: Craig Bolon, Newton, MA (US)

Correspondence Address: IP Patent Docketing;K&L GATES LLP, 599 Lexington Avenue, 33rd Floor, New York, NY, 10022-6030, US

(21) Appl. No.: 12/548,082

(22) Filed: Aug. 26, 2009

Related U.S. Application Data
(60) Provisional application No. 61/190,211, filed on Aug. 27, 2008.

(51) Int. Cl. G06F 15/16

(52) U.S. Cl. 709/203

(57) ABSTRACT

Systems and processes are provided for maintaining threaded context in a Web application. For example, a process is provided which includes assembling and sending to a user computer a Web page document, the Web page document including a threaded context packet in an element that will be automatically returned unchanged. The process further includes receiving a request for a second Web page document including the threaded context packet, and interpreting the unchanged content of the threaded context packet to determine the context when the Web page document was transmitted.

### CROSS-REFERENCE TO RELATED APPLICATIONS

This application claims priority to U.S. Provisional Patent Application No. 61/190,211, filed Aug. 27, 2008, the entirety of which is incorporated by reference herein.

### BACKGROUND

Since a description of FORTRAN by John W. Backus and co-workers at International Business Machines Corp. in 1954, most procedural programming languages have organized computer software according to a threaded paradigm. In such a paradigm, flow of control goes through a linked succession (or thread) of procedural functions. Such functions may invoke other functions, passing parameters, and may return to functions that invoked them, passing results. Users of procedurally oriented computer software have become accustomed to a context of linked operations, partly as a consequence of a threaded paradigm.

Descriptions by Tim Berners-Lee in 1989 of linked documents delivered from server computers over networks, now called Web pages, represent computer software with a nonthreaded paradigm. A one-way information transfer allows a Web page, at a user's direction, to link to a Web page and pass parameters to it, but there is no concept of a Web page returning to the previous Web page and passing results. The users of this technology are typically able to navigate within a pool of pages. A “history” of a user's path from page to page may be maintained by Web page viewing programs called “browsers.” However, browser history use lacks strictly coupled, stepwise sequencing and transfer of information, including results, that would occur if context were maintained according to a threaded paradigm.

Software in script languages, interpreted and executed by browsers, augments documents of many Web pages to present and manage information. Brendan Eich implemented the first browser script language, JavaScript® in 1995. ECMAScript™ a similar script language that became widely supported by browsers, was described in 1997 by the European Computer Manufacturers Association and has become an ISO standard.

Coordinated sets of Web pages, called Web application software, has potential to replace software that runs on a user's own computer when there are multiple users sharing data or when data security is best coordinated at a different location. A key advantage is eliminating the need to upgrade or maintain software on user computers; only software on server computers that prepare and deliver Web page documents will need upgrades or maintenance. However, to provide behavior and reliability similar to software running on user computers, Web application software needs an efficient technique for maintaining threaded context. As concerns grow about reliability and security of software that operates over shared networks, Web application software will also need to assure that context information remains valid and has not been changed or forged.

### Description of Earlier Systems

In order to create software delivered through Web pages that maintains a form of context, named tokens of information called “cookies” can be sent with Web page documents, and browsers usually store and retrieve them on request, a technology developed by Lou Montulli in 1994. The term, cookie, was adapted from “magic cookie,” computer jargon of the 1970s denoting an apparently meaningless value that acts as a key to some action or service. When a cookie is accepted, its information is stored on the computer to which it is sent and remains available for a time that the cookie may request, unless a user of the computer deletes or alters it. While it remains available and unchanged, a cookie's information can serve as a marker of state for an instance of Web page use; but cookies will not maintain reliable context, because they can be refused, altered or deleted.

In 1996, Arun Iyengar developed techniques to maintain state information for a sequence of Web page views that can include “continuation,” or repeated, views of a page. Iyengar's techniques require either server or user computers to identify specific continuations for viewing a particular page and, in some cases, to identify requirements to preserve state information, a burden on one computer or the other and a limitation to the generality of these techniques. There are also circumstances, particularly with Web application software, in which continuation views of a page are more appropriately treated as not adding to a sequence of page views maintained as threaded context.

There are several approaches for using state markers to identify context information. Perhaps the most common are to use a state marker as a key to a database record, a data file or a memory map and then to apply information retrieved from the database, data file or memory map in ways that a procedural program could have used information maintained through its threaded context. There is significant processing cost to store and retrieve context information, and there is significant overhead to manage a pool of context information over time. For example, a pool of context information held in a memory map must be persistently backed up to provide tolerance for power outages and other faults; a pool of context information held in server-based storage must be scanned periodically to purge expired records.

Employing a state marker maintained by a user computer to provide context information typically involves at least the following sequence of operations:

1) A browser running on a user computer requests a Web page.

2) A server computer sends the page, requesting a state marker.

3) The user computer sends the state marker.

4) The server computer retrieves context information.

User computer actions in such a sequence may be augmented by script software imbedded in a Web page document. Before context information can be acted on there are multiple network transmissions, and there is some form of information retrieval by a server computer.

State management of Web server software has been achieved by other means. In 2000 Gary Burd and co-workers described techniques for representing and recovering the state of Web page components with variable properties after a user has interacted with the page. They use transportable state structures to maintain one or more of: (1) state information related to properties of server-side control objects, (2) hierarchical information used by the server to locate a server-side control object into which state information is to be loaded, and (3) an integrity code allowing the server to see whether a transportable state structure was altered during the exchange between server and user. However, those techniques do not provide the context for a sequence of pages, parameters and results.

Also in 2000, Galen Hunt described techniques to store and recover states of network servers by configuring a network to maintain information, including an approach of continually rerouting state information among network clients. Such approaches will need a potentially complex network infrastructure. They are described for client-server software architectures, in which client computer software calls an application program interface to access a server object, rather than for Web application software architectures.

Some context requirements for Web application software differ from those for Web pages that have commonly been implemented using state markers. Web application software is typically used in sessions that are not interrupted by viewing pages other than those the application provides or manages. The sessions are typically continuous; there is typically no need for them to extend over long periods of inactivity.

### SUMMARY

Some example embodiments of the present invention provide a process for maintaining threaded context in a Web application, which may include assembling and sending to a user computer a Web page document, with a server computer, the Web page document including a threaded context packet in an element that will be automatically returned unchanged; receiving, with the server computer, a request for a second Web page document, from the user computer, the request including the threaded context packet; and interpreting, with the server computer, the unchanged content of the threaded context packet from the user computer to determine the context at the server computer when the Web page document was transmitted; wherein the threaded context packet includes an ordered list of subpackets, each representing access to a Web page in a thread of Web page accesses, and including within each subpacket, a list of values including a Web page identifier value; and wherein a selected subpacket in the threaded context packet identifies a most recent Web page access.

In some example embodiments, the selected subpacket may be the first subpacket in the threaded context packet.

In some example embodiments, the server computer may construct said threaded context packet to represent operations for at least one Web page to which access is represented in said list of subpackets.

In some example embodiments, the server computer may interpret said threaded context packet from the user computer to control its operations for at least one Web page to which access is represented in said list of subpackets.

In some example embodiments, the server computer may modify the threaded context packet to represent its operations for at least one Web page to which access is represented in said list of subpackets.

In some example embodiments, the list of subpackets may be ordered by tag values in said lists of values of said subpackets.

In some example embodiments, at least one data aggregate may be identified in said lists of values of said subpackets by a tag value that is symbolically associated with said data aggregate.

In some example embodiments, at least one of said lists of values of said subpackets may contain parameter values for corresponding Web pages.

In some example embodiments, at least one of said lists of values of said subpackets may contain result values for corresponding Web pages.

In some example embodiments, at least one of said lists of values of said subpackets may contain status values for corresponding Web pages.

In some example embodiments, an access to a new, different Web page may be represented by adding at the server computer a corresponding subpacket to said threaded context packet after a subpacket identifying a most recent Web page access.

In some example embodiments, an access to a previous, different Web page may be represented by removing a subpacket identifying a most recent Web page access from said threaded context packet.

In some example embodiments, a discontiguous repeated access to a Web page may be represented by removing from said threaded context packet subpackets following a subpacket representing a prior access to said Web page.

In some example embodiments, said discontiguous repeated access to a Web page may be represented by setting at least one value other than said Web page identifier in said subpacket representing a prior access to said Web page.

In some example embodiments, a discontiguous repeated access to a Web page may be represented by adding a corresponding subpacket to said threaded context packet.

In some example embodiments, an access to a Web page under a predetermined circumstance may not be represented by a corresponding subpacket in said threaded context packet.

In some example embodiments, an access to a Web page under a predetermined circumstance may be represented by first removing all subpackets from said threaded context packet and then adding a corresponding subpacket.

In some example embodiments, responsive to the threaded context packet containing no prior subpackets, an access to a previous Web page may be represented by leaving said subpacket identifying the most recent Web page access in said list of subpackets of said threaded context packet.

In some example embodiments, an access to a previous Web page may be represented by replacing said subpacket identifying the most recent Web page access in said list of subpackets with a subpacket corresponding to a default Web page.

In some example embodiments, said threaded context packet may further include at least one external list of values.

In some example embodiments, at least one of said external lists of values may be ordered by tag values.

In some example embodiments, at least one data aggregate may be identified in said external lists of values by tag values that are symbolically associated with said data aggregates.

In some example embodiments, said external lists of values may include at least one of a time value, a content validation value, a server identification value, and a user identification value.

In some example embodiments, said threaded context packet may further include within at least one of said subpackets, at least one additional list of values for corresponding Web pages.

In some example embodiments, at least one of said additional lists of values may be ordered by tag values.

In some example embodiments, at least one data aggregate may be identified in said additional lists of values by a tag value that is symbolically associated with said data aggregate.

In some example embodiments, at least one of said additional lists of values may contain parameter values for the corresponding Web page, result values for the corresponding Web page, and status values for the corresponding Web page.

In some example embodiments, said threaded context packet may be encapsulated before being sent to said user computer by at least one of converting numbers to byte sequence equivalents, converting numbers to character sequence equivalents, recoding long character codes using shorter equivalents, lossless compression, encryption, and distribution through a subset of character codes.

Other example embodiments may provide a system for maintaining a threaded context in a Web application, which may include an application server including a server component and an application component; wherein the application component assembles a Web page document, including a threaded context packet in an element that will be automatically returned unchanged; wherein the server component sends the Web page document, including the threaded context packet, to a user computer, in response to a first Web page request from the user computer; wherein the server component receives a request for a second Web page document, from the user computer, the request including the threaded context packet; wherein the application component interprets the unchanged content of the threaded context packet from the user computer to determine the context at the server computer when the Web page document was transmitted; and wherein the threaded context packet includes an ordered list of subpackets, each representing access to a Web page in a thread of Web page accesses, each subpacket including a list of values including a Web page identifier value.

Other example embodiments may provide a system for maintaining a threaded context in a Web application, which may include an element for assembling a Web page document, including a threaded context packet in an element that will be automatically returned unchanged; an element for sending the Web page document, including the threaded context packet, to a user computer, in response to a first Web page request from the user computer; an element for receiving a request for a second Web page document, from the user computer, the request including the threaded context packet; and an element for interpreting the unchanged content of the threaded context packet from the user computer to determine the context when the Web page document was transmitted; wherein the threaded context packet includes an ordered list of subpackets, each representing access to a Web page in a thread of Web page accesses, each subpacket including a list of values including a Web page identifier value.

And other example embodiments may provide an article of manufacture which may include a computer readable medium containing instructions which, when executed by a computer, cause the computer to assemble a Web page document, including a threaded context packet in an element that will be automatically returned unchanged; send the Web page document, including the threaded context packet, to a user computer, in response to a first Web page request from the user computer; receive a request for a second Web page document, from the user computer, the request including the threaded context packet; and interpret the unchanged content of the threaded context packet from the user computer to determine the context when the Web page document was transmitted; wherein the threaded context packet includes an ordered list of subpackets, each representing access to a Web page in a thread of Web page accesses, each subpacket including a list of values including a Web page identifier value.

### BRIEF SUMMARY OF THE DRAWINGS

FIG. 1A illustrates a TcPack subpacket list in accordance with an example embodiment of the present invention.

FIG. 1B illustrates a TcPack subpacket list in accordance with an example embodiment of the present invention.

FIG. 2 illustrates a system in accordance with an example embodiment of the present invention.

### DETAILED DESCRIPTION OF EXAMPLE EMBODIMENTS

Example embodiments of the present invention provide efficient threaded context for Web application software, specifically considering circumstances of typical use. For example, security concerns may make it unacceptable for such information to be stored on user computers as readily identifiable tokens; however, continuous sessions of Web application software use may make it unnecessary to store context information on user computers in such ways.

In order to provide efficient threaded context for Web application software, example embodiments of the present invention also consider characteristics of information typically exchanged in procedural software using threaded context. Such information consists of compact values representing quantities, measurements, indexes, offsets or references to information elements or aggregates. The process of the present invention represents a threaded context using such values. Representing hierarchical information typically contained in aggregate objects, directly within a threaded context, is inefficient and unnecessary.

In accordance with an embodiment of the present invention, a process uses a “threaded context packet,” or TcPack, to represent a threaded context, transmitting such a packet as content of an element of a Web page that will be automatically returned unchanged, and accessing it from response data on the next request for a page. Content of a TcPack may include a linear, ordered sequence of compact values, including:

1) A list of subpackets, each representing a page in a thread of pages, and

2) Within each subpacket, a page identifier value in a list of values,

using “list” to mean a linear, ordered sequence and using “subpacket” to mean one or more lists of values always including a page identifier value in a list of values.

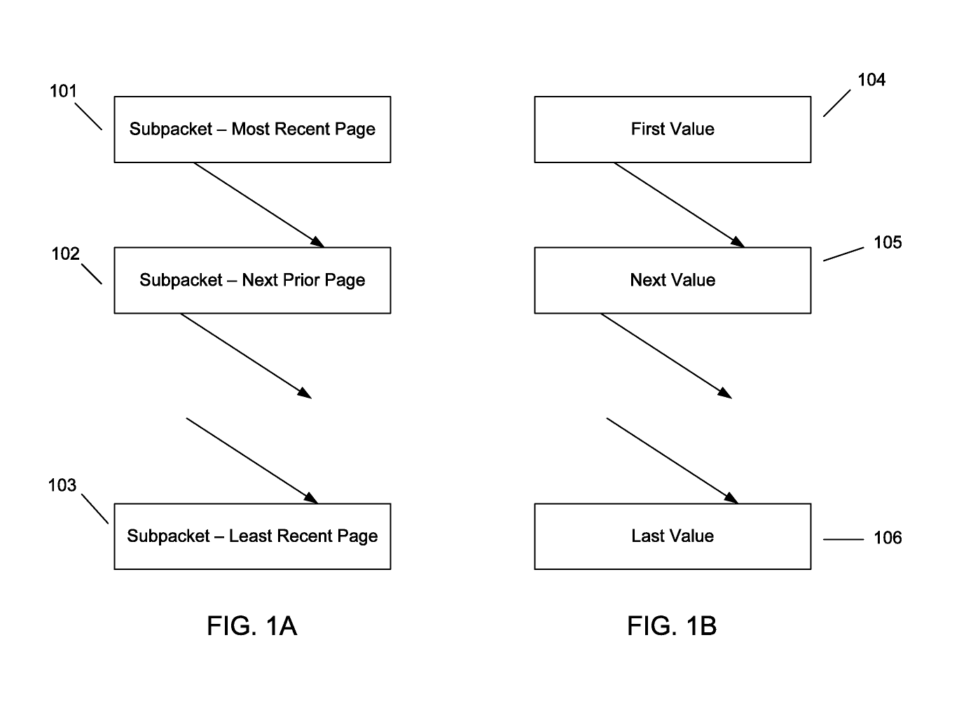

FIG. 1A shows schematically the content of a TcPack, a list of subpackets, each representing a Web page, in an order from the most recent page of a session 101 through a thread of prior pages 102 to the least recent page 103. Tag values may be used to establish an order of subpackets. A TcPack may contain optional lists of values before the subpacket list, after the subpacket list or both. Content for a subpacket consists of a page identifier value, in a list of values that may contain other values, and optional lists of values relevant to a page that may occur before the list of values that contains a page identifier, after that list of values or both.

FIG. 1B shows schematically a TcPack list of values 104-106. A list of values may have fixed or variable length, may be of any length, and may be identified, described or delimited by a value or sequence of values. Tag values may be used to establish an order of values in a list. The order, formats and meanings of values in a list may be specific to a page. Arrows in these figures are schematic only, denoting ordering; they do not indicate implementations or formats.

In contrast to the use of a state marker, the use of a TcPack involves a simpler sequence of operations. For example, a user computer may request a conventional Web page to initiate a session. The initial page typically performs a login that validates user credentials and retrieves user authorizations based on information maintained by a server computer. After that, each page sent in a session includes a TcPack that returns unchanged when a subsequent page is requested from a server. A TcPack is not a marker, and its value is not arbitrary. Instead, a TcPack describes a threaded context in a linear sequence of values, allowing a server computer to react immediately, without extra network transmissions, without retrieving context information from elsewhere and without excess overhead to maintain context information. It is noted that use of TcPack context is by session.

Interpreting a TcPack allows a server computer to conduct operations for a Web page under the conditions present when the page was most recently sent to the user computer, knowing the thread of page accesses leading to that page. When a new, different Web page is to be sent, a subpacket is added to the current TcPack representing the new page as the most recent page, with optional values including initial parameter values as needed for the page. Server software for the new page ordinarily receives control, and uses values in the context to guide operations and indicate status. After its operations, the new page is sent out with the modified TcPack. For return to the previous, different page, the subpacket representing the most recent page, with any optional values, is removed from the current TcPack. Server software for the previous page ordinarily receives control, obtaining optional return values that may be transmitted in the context and using values in the context to guide operations and indicate status. After its operations, the previous page is sent out with the modified TcPack.

Context as represented in a TcPack treats contiguously repeated accesses to a Web page as one access and does not represent such repeated accesses separately. If a page is accessed that is not a repeat of the most recent page but appears elsewhere in context as a prior page access, use of a TcPack by a Web application depends on strategy, circumstances or both. An application may remove intervening pages from context and restore context for the prior page access, or it may remove the intervening pages from context and reinitialize context for the prior page, or it may add such a page access to context separately from the prior access.

Web application software may disregard part or all of threaded context, based on strategy, circumstances or both. When a new page is accessed under circumstances in which a return to the most recent page would be inappropriate, Web application software may remove the most recent page identifier and its optional values from the current TcPack and add a new page identifier value as the most recent page, with optional values as needed. Server software for the new page receives control and uses values in the context to guide operations and indicate status. The new page is sent out with the modified TcPack. When a new page is accessed under circumstances in which all prior context becomes meaningless, Web application software may remove all page identifiers and their optional values from the current TcPack and add a new page identifier value as the most recent page, with optional values as needed including initial parameter values. Server software for the new page receives control and uses values in the context to guide operations and indicate status. The new page is sent out with the modified TcPack. When trying to return to the previous page, if there is no prior context, Web application software may access a default page instead, supplying it with initial parameter values as needed, or it may repeat access to the most recent page.

A TcPack can optionally include lists of values outside the subpacket list, other values in the subpacket value list that includes a page identifier value and other lists of page values within subpackets. Optional TcPack values can improve security, integrity, flexibility and interpage communication. At initial page access page values can be set. Afterward page values can be changed to represent changes in page operation or status. Optional TcPack values include:

a time value, typically specifying time of page origination

a content validation value, such as a checksum

a server identification value or list of values

a user identification value or list of values

within a subpacket, a list of parameter values for a page

within a subpacket, a list of return values for a page

To help assure reliable operations, TcPack content will preferably include a fine-resolution time value, will preferably include a form of content validation, such as a checksum value, and will preferably be encrypted. Using a fine-resolution time value with encryption causes a TcPack to change at each page access, though it may represent unchanged context, and helps assure that a TcPack has not been covertly interpreted. Using a form of content validation helps assure that a TcPack has not been altered or forged. Server computer software can add security against TcPack mishandling by using a time value to reject an expired TcPack and by changing an encryption key periodically.

When a user viewing a Web page with a TcPack asks to view a different page, preferably pages will be configured such that the browser will request the same page, and response data sent with such a request will be processed by server software to identify the different page and transfer to it through internal operations. With such an approach, page data cleanup and recording can be performed, user authorizations can be checked, and server software for a page needs to recognize only that page's values among those received in a TcPack, can easily set initial values for another page and can easily return values to a previous page. Since a page is able to transmit information to a server that can specify an unlimited variety of options that may be chosen by a user, the preferred approach in no way restricts the versatility of Web pages.

A TcPack is preferably sent with a Web page in a nondisplayed element of a document that will be automatically returned unchanged without requiring special script software, such as a hidden input field's initial value. While TcPack content may be sent with a Web page as internally assembled, provided its values are expressed as characters, TcPack content can also be encapsulated in a modified sequence of data to be sent with a Web page using combinations of one or more of the following, optional procedures:

Numbers are converted to byte or character sequence equivalents

Unicode or other long character codes are recoded using shorter equivalents.

The data sequence is losslessly compressed.

The data sequence is encrypted.

The data sequence is distributed through a subset of character codes.

Interpretation of TcPack content as returned to a server computer requires the reverse sequence of inverting the optional encapsulation procedures.

Representation of values and lists in a TcPack can take many forms well known in software arts. However, identifying data aggregates is of concern. Such data are typical intermediates involved in generating Web pages. Procedural software executing on a conventional computer ultimately represents such objects as memory addresses of start points or descriptors, but such a representation is not feasible for a TcPack, because most software environments do not guarantee that server software will always occupy the same memory addresses. A TcPack must therefore represent such objects as tags, sufficient to identify or retrieve corresponding objects when required. For example, the identification of aggregates may use keys in database tables or in memory maps or may use numbers, characters or combinations that are symbolically associated with the aggregates.

Although not necessary, it can be helpful when implementing a TcPack to restrict all values to one format. Many alternatives are available for representing values, such as long integers and character strings. Many alternatives are also available for representing lists in a TcPack. For example, a variable-length list may consist of a count of its elements followed by values of elements, or it may consist of a set of element ordinals, each adjacent to a corresponding value, with flags to identify first elements, last elements or both. A list may be ordered by positional occurrence of elements. Alternatively, tag values may associate a symbol with each other element in a list, establishing an order through the characteristics and values of the tags. A list can be limited to a single element without ordering. Choices of value and list representation will usually be determined by compactness and flexibility of data and by efficiency of encoding, decoding, assembly and disassembly procedures.

Web application software may set or change values in a TcPack to reflect operations and status of pages. Optional page value lists can provide scratchpads. When server software supports multiple patterns of user authorization or activity, optional TcPack content identifying a user or describing a user's authorizations or activities can eliminate a need to retrieve stored information about the user. When server software is provided by multiple computers, optional TcPack content identifying a server or describing a server's network configuration allows a computer that responds to a request for an operation to see whether or not it was the computer that most recently sent a page. In some Web applications that use memory caching, such optional TcPack content can help provide improved performance.

As previously described, optional TcPack content of a time value can insure that each TcPack is different, even when it specifies the same context as another. Time resolution needs to be fine enough that there is little chance a TcPack for a page will record the same time as another TcPack for the same page. With many encryption algorithms it is advantageous to place a time value at the end of a TcPack data sequence where encryption begins, propagating changes through the entire sequence. The optional validity check in a TcPack can be provided by several techniques that are well known in software arts. Checksums and higher-order cyclic redundancy checks, preferably over the largest modular unit of TcPack content, are helpful in assuring context validity and, when combined with encryption, in defending against TcPack changes and forgery.

For the optional steps of compressing and encrypting the data sequence of a TcPack, one skilled in software arts will know about several widely used algorithms. For example, lossless data compression is often performed by such algorithms as those described by Claude Shannon in 1948, by David Huffman in 1952, by Abraham Lempel and Jacob Ziv in 1977 and by Terry Welch in 1984; and encryption is often performed by algorithms such as those described by Ronald Rivest, Adi Shamir and Leonard Adleman in 1978 and by Joan Daemen and Vincent Rijmen in 2000. Choices among techniques will be usually be determined by compactness of data, efficiency of processing and resistance of encryption to attack.

For the optional step of distributing the data sequence for a TcPack through a subset of character codes, one skilled in software arts will know several techniques and will recognize that certain character codes have control interpretations and may cause disruptive behavior or may be altered or removed by browsers or data transmission. Treatment of all data as numeric and conversion to character equivalents as binary, octal, decimal or hexadecimal numbers or as numbers with some other base can be convenient but usually results in bulky data. Bit shifting and table lookup techniques or both can be used to distribute a data sequence reversibly, interpreted as a sequence of bits, onto a subset of character codes that do not include codes with control interpretations or codes that may cause disruptive behavior or may be altered or removed by browsers or data transmission. For example, the 7-bit ASCII characters with hexadecimal values of 30 through 6F and the 16-bit Unicode characters with hexadecimal values of 4000 through 7FFF are usually reliable in components of Web page documents.

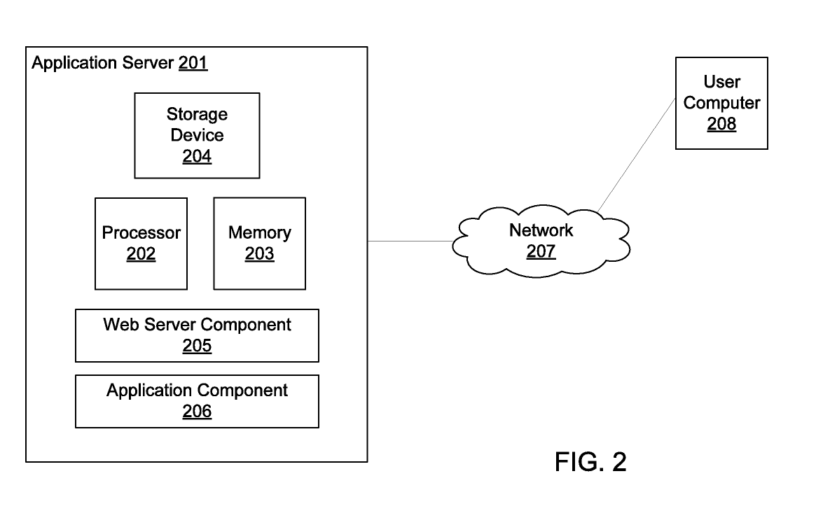

Other example embodiments of the present invention provide for systems which provide a threaded context for Web application software. Such an example system is illustrated in FIG. 2. As shown in the figure, example embodiments may include an application server 201. The application server 201 may include a processor 202, a memory 203, and a storage device 204. In addition, the server 201 may also include an I/O device, through which it may be in communication with a network 207, e.g., the Internet.

The application server 201 may also include a Web server component 205. The Web server component 205 may be configured to process all of the transactions typically associated with Web pages. For instance, the Web server component 205 may be configured to receive requests for Web pages, to process requests for Web pages, and to transmit Web page data to client devices 208 and applications, etc. The Web server component 205 may be implemented using Web server systems currently available, such as, e.g., the Apache Web server software, which may, for instance, be stored on the storage device 204 and executed using the processor 202 and memory 203. Of course, the Web server component 205 may be implemented using other systems.

The application server 201 may also include an application component 206 in communication with the Web server component 205. The application component 206 may provide all of the services necessary to facilitate a particular Web application. For instance, the application component 206 may be configured to receive Web page requests from the Web server component 205. The application component 206 may also be configured to interpret those requests and to make available appropriate Web page data in response to the request, which may be communicated to a user device 208 through the Web server component 205.

The application component 206 may also be configured to utilize TcPacks as described above. For example, upon receiving an initial request from a user, the application component 206 may be configured to create a response to the request. For example, the application component 206 may identify an initial Web page to be provided to the user. As described above, the application component 206 is also configured to include a TcPack in the response. Here the application component 206 will add a subpacket to the TcPack identifying the page to be served as the most recent page, and including all of the other information described more fully above. The application component 206 then inserts the TcPack in the response in an element that will be returned without alteration, also as further described above.

Further, the application component 206 is configured to receive requests which contain TcPacks. For instance, if, having received the initial Web page requested, a user follows a link on that page to another, new page, a request for that page will be received at the application component 206. As described above, the request will include a TcPack containing a record of the Web session up to that point. The application component 206 will then access the TcPack and reference the information included in the TcPack. That information may be used by the application component 206 to form a response to the present request, or for any of the purposes described above. The application component 206 may then update the TcPack with a new subpacket, etc., and may create the appropriate response.

It will be understood that the procedures described herein may be implemented using one or more computer programs or components. These components may be provided as a series of computer instructions on any conventional computer-readable medium, including RAM, ROM, flash memory, magnetic or optical disks, optical memory, or other storage media. The instructions may be configured to be executed by a processor, which when executing the series of computer instructions performs or facilitates the performance of all or part of the disclosed methods and procedures.

It will further be appreciated that the above-described methods and procedures may be provided using the systems disclosed herein, or on other types of systems. The methods and procedures, unless expressly limited, are not intended to be read to require particular actors or systems performing particular elements of the methods.

It will also be appreciated that the system components discussed herein may be provided as hardware, firmware, software or any combination thereof. If provided as software, such software may be stored in memory, for example in RAM, ROM, flash or other non-volatile memory, etc., or may be stored on another machine readable medium, such as magnetic or optical media, etc. In addition such software may be preloaded, or may be acquired and stored during functioning of a system.

In the preceding specification, the present invention has been described with reference to specific example embodiments thereof. It will, however, be evident that various modifications and changes may be made thereunto without departing from the broader spirit and scope of the present invention. The description and drawings are accordingly to be regarded in an illustrative rather than restrictive sense.

1. A process for maintaining threaded context in a Web application, comprising:
assembling and sending to a user computer a Web page document, with a server computer, the Web page document including a threaded context packet in an element that will be automatically returned unchanged;
receiving, with the server computer, a request for a second Web page document, from the user computer, the request including the threaded context packet; and
interpreting, with the server computer, the unchanged content of the threaded context packet from the user computer to determine the context at the server computer when the Web page document was transmitted;
wherein the threaded context packet includes an ordered list of subpackets, each representing access to a Web page in a thread of Web page accesses, and including within each subpacket, a list of values including a Web page identifier value; and
wherein a selected subpacket in the threaded context packet identifies a most recent Web page access.

2. The process of claim 1, wherein the selected subpacket is the first subpacket in the threaded context packet.

3. The process of claim 1 wherein the server computer constructs said threaded context packet to represent operations for at least one Web page to which access is represented in said list of subpackets.

4. The process of claim 1 wherein the server computer interprets said threaded context packet from the user computer to control its operations for at least one Web page to which access is represented in said list of subpackets.

5. The process of claim 1 wherein the server computer modifies the threaded context packet to represent its operations for at least one Web page to which access is represented in said list of subpackets.

6. The process of claim 1 wherein the list of subpackets is ordered by tag values in said lists of values of said subpackets.

7. The process of claim 1 wherein at least one data aggregate is identified in said lists of values of said subpackets by a tag value that is symbolically associated with said data aggregate.

8. The process of claim 1 wherein at least one of said lists of values of said subpackets contains parameter values for corresponding Web pages.

9. The process of claim 1 wherein at least one of said lists of values of said subpackets contains result values for corresponding Web pages.

10. The process of claim 1 wherein at least one of said lists of values of said subpackets contains status values for corresponding Web pages.

11. The process of claim 1 wherein an access to a new, different Web page is represented by adding at the server computer a corresponding subpacket to said threaded context packet after a subpacket identifying a most recent Web page access.

12. The process of claim 1 wherein an access to a previous, different Web page is represented by removing a subpacket identifying a most recent Web page access from said threaded context packet.

13. The process of claim 1 wherein a discontiguous repeated access to a Web page is represented by removing from said threaded context packet subpackets following a subpacket representing a prior access to said Web page.

14. The process of claim 12 wherein said discontiguous repeated access to a Web page is represented by setting at least one value other than said Web page identifier in said subpacket representing a prior access to said Web page.

15. The process of claim 1 wherein a discontiguous repeated access to a Web page is represented by adding a corresponding subpacket to said threaded context packet.

16. The process of claim 1 wherein an access to a Web page under a predetermined circumstance is not represented by a corresponding subpacket in said threaded context packet.

17. The process of claim 1 wherein an access to a Web page under a predetermined circumstance is represented by first removing all subpackets from said threaded context packet and then adding a corresponding subpacket.

18. The process of claim 1 wherein, responsive to the threaded context packet containing no prior subpackets, an access to a previous Web page is represented by leaving said subpacket identifying the most recent Web page access in said list of subpackets of said threaded context packet.

19. The process of claim 1 wherein, responsive to the threaded context packet containing no prior subpackets, an access to a previous Web page is represented by replacing said subpacket identifying the most recent Web page access in said list of subpackets with a subpacket corresponding to a default Web page.

20. The process of claim 1 wherein said threaded context packet further includes at least one external list of values.

21. The process of claim 19 wherein at least one of said external lists of values is ordered by tag values.

22. The process of claim 19 wherein at least one data aggregate is identified in said external lists of values by tag values that are symbolically associated with said data aggregates.

23. The process of claim 19 wherein said external lists of values include at least one of a time value, a content validation value, a server identification value, and a user identification value.

24. The process of claim 1 wherein said threaded context packet further includes within at least one of said subpackets, at least one additional list of values for corresponding Web pages.

25. The process of claim 23 wherein at least one of said additional lists of values is ordered by tag values.

26. The process of claim 23 wherein at least one data aggregate is identified in said additional lists of values by a tag value that is symbolically associated with said data aggregate.

27. The process of claim 23 wherein at least one of said additional lists of values contains parameter values for the corresponding Web page, result values for the corresponding Web page, and status values for the corresponding Web page.

28. The process of claim 1 wherein said threaded context packet is encapsulated before being sent to said user computer by at least one of converting numbers to byte sequence equivalents, converting numbers to character sequence equivalents, recoding long character codes using shorter equivalents, lossless compression, encryption, and distribution through a subset of character codes.

29. A system for maintaining a threaded context in a Web application, comprising:
an application server including a server component and an application component;
wherein the application component assembles a Web page document, including a threaded context packet in an element that will be automatically returned unchanged;
wherein the server component sends the Web page document, including the threaded context packet, to a user computer, in response to a first Web page request from the user computer;
wherein the server component receives a request for a second Web page document, from the user computer, the request including the threaded context packet;
wherein the application component interprets the unchanged content of the threaded context packet from the user computer to determine the context at the server computer when the Web page document was transmitted; and
wherein the threaded context packet includes an ordered list of subpackets, each representing access to a Web page in a thread of Web page accesses, each subpacket including a list of values including a Web page identifier value.

30. A system for maintaining a threaded context in a Web application, comprising:
means for assembling a Web page document, including a threaded context packet in an element that will be automatically returned unchanged;
means for sending the Web page document, including the threaded context packet, to a user computer, in response to a first Web page request from the user computer;
means for receiving a request for a second Web page document, from the user computer, the request including the threaded context packet; and
means for interpreting the unchanged content of the threaded context packet from the user computer to determine the context when the Web page document was transmitted;
wherein the threaded context packet includes an ordered list of subpackets, each representing access to a Web page in a thread of Web page accesses, each subpacket including a list of values including a Web page identifier value.

31. An article of manufacture comprising a computer readable medium containing instructions which, when executed by a computer, cause the computer to:
assemble a Web page document, including a threaded context packet in an element that will be automatically returned unchanged;
send the Web page document, including the threaded context packet, to a user computer, in response to a first Web page request from the user computer;
receive a request for a second Web page document, from the user computer, the request including the threaded context packet; and
interpret the unchanged content of the threaded context packet from the user computer to determine the context when the Web page document was transmitted;
wherein the threaded context packet includes an ordered list of subpackets, each representing access to a Web page in a thread of Web page accesses, each subpacket including a list of values including a Web page identifier value.
